(19) United States
(12) Patent Application Publication
(10) Pub. No.: US 2018/0125263 A1
(43) Pub. Date: May 10, 2018

(54) DISPOSABLE BABY CHANGE MAT

(71) Applicant: Lorraine Kozlovic, Kent Town (AU)

(72) Inventor: Lorraine Kozlovic, Kent Town (AU)

(21) Appl. No.: 15/795,363

(22) Filed: Oct. 27, 2017

(30) Foreign Application Priority Data
Nov. 7, 2016 (AU) 2016904543

(51) Int. Cl. A47D 15/00; B32B 3/26

(52) U.S. Cl. CPC A47D 15/003; B32B 3/266; B32B 2250/04; B32B 2555/00; B32B 2307/744; B32B 2307/7265

(57) ABSTRACT

A baby change mat comprising four layers, wherein two layers are absorbent and two layers waterproof, and wherein the outer waterproof layer contains a slit. In the event of the mat being soiled, the mat can be completely enclosed by inverting the outer layer for easy and mess-free disposal.

### FIELD OF THE INVENTION

The present invention relates to a disposable baby change mat.

### BACKGROUND TO THE INVENTION

Baby changing mats are commonly used by caregivers when in and outside the home for the purposes of hygiene, cleanliness and convenience. These mats provide a work surface for changing an infant's nappy and usually comprise of an absorbent top layer and a leak-proof bottom layer. These mats are designed for multiple use, however it is possible that the infant may urinate or defecate whilst being changed, soiling the mat or the mat may become soiled during the changing process.

In such circumstances it can be difficult to dispose of the mat quickly and cleanly.

The object of this invention is to provide a disposable baby change mat that alleviates the above problems, or at least provides the public with a useful alternative.

### SUMMARY OF THE INVENTION

In a first aspect the invention there is proposed a baby change mat comprising a base mat comprising a plurality of layers and wherein the mat can be folded inwards and an outer layer contains an opening allowing for the said layer to be inverted in order to enclose the mat for disposal.

In preference the baby change mat comprises four layers.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1A is an expanded view of a baby change mat in four layers;

FIG. 1B is a perspective view of a baby change mat in four layers;

FIG. 2 is a perspective view of a baby change mat as placed on a changing surface;

FIG. 3 is a perspective view of a soiled baby change mat;

FIG. 4 is a perspective view of a soiled baby change mat being folded to enclose soiled material;

FIG. 5 is a perspective view of a soiled baby change mat folded to enclose the soiled material;

FIG. 6 is a perspective view of a baby change mat with the slit on the bottom layer exposed;

FIG. 7 is a perspective view of a baby change mat with the bottom layer partially inverted; and

FIG. 8 is a perspective view of a baby change mat with the bottom layer completely inverted.

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

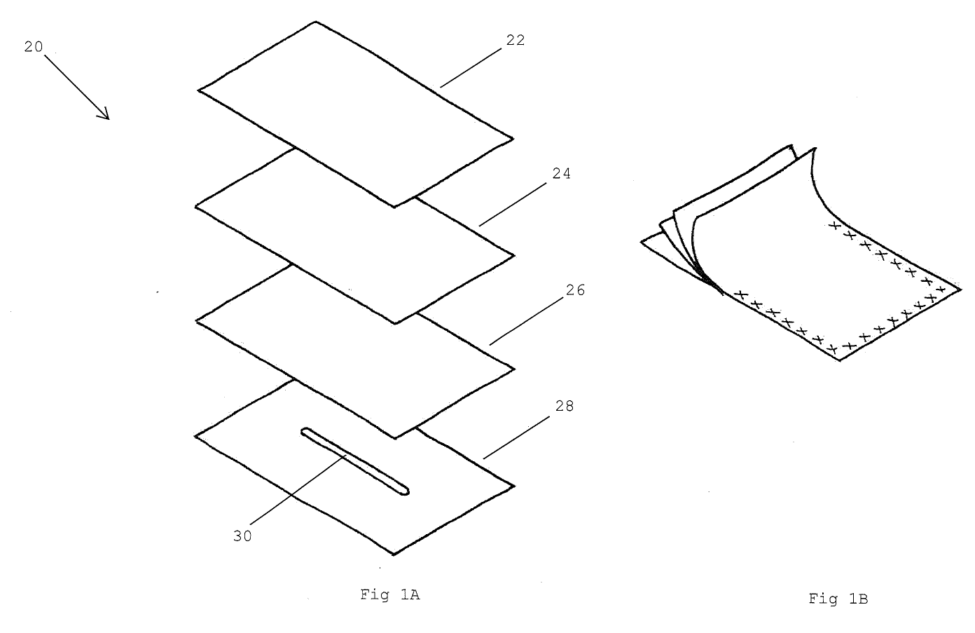

Turning now to the drawings there is illustrated in FIG. 1A four layers of a baby change mat 20 comprising a first layer 22, a second layer 24, a third layer 26 and a fourth layer 28. The first layer 22 also acts as a top layer when the mat 20 is laid on a changing surface, for example a changing station in a public bathroom or any other available flat surface. The first layer 22 and second layer 24 are comprised of a soft and absorbent material such as cotton velour or any other suitable absorbent material. The third layer 26 is comprised of a leak proof material such as polyurethane laminate (PUL) or any other suitable waterproof material. The fourth layer 28 also acts as a bottom layer and is laid on the changing surface. In preference, the outer surface of the fourth layer may include non-slip properties to reduce movement against the changing surface.

It is also to be understood that layer 24 may indeed be made from several layers that overall form the absorbent layer.

The fourth layer 28 contains a slit 30 which is a narrow opening located at the centre of the fourth layer 28.

All of the four layers are outer edge glue sealed during manufacture to form a single changing mat 20 as seen in FIG. 1B.

The mat 20 is disposable however can be reused in the event that the changing of the infant is uneventful, and in such circumstances is used as any other known changing mats. The user can then decide whether to dispose of the mat or fold and store for later use.

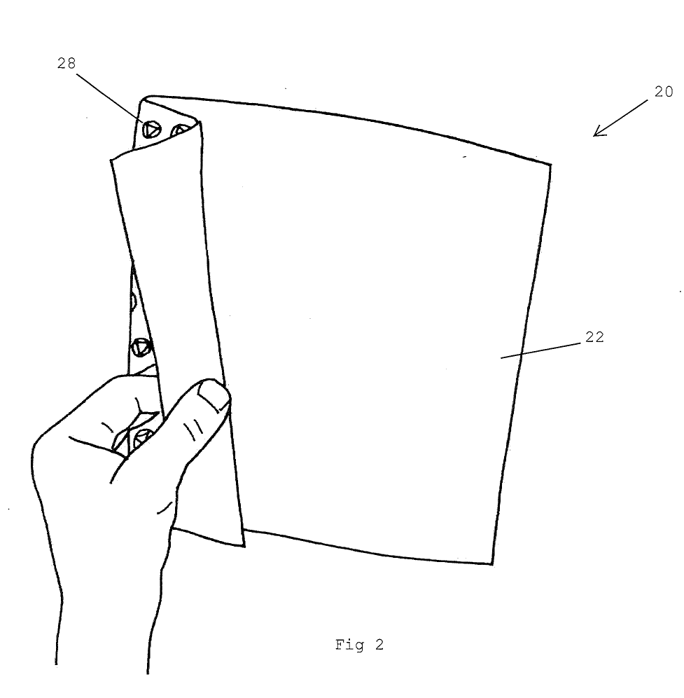

Generally use of the mat 20 includes it being laid on a flat surface with the fourth layer 28 facing the surface and the first layer 22 facing upwards as seen in FIG. 2. The infant is laid on the first layer 22 and the user attends to changing of the nappy. It is possible that between removing the soiled nappy, cleaning the infant and replacing with a fresh nappy, the infant may soil itself on the mat 20. This can be very inconvenient for the user as it is difficult to quickly and cleanly dispose of the mat without getting the soil material 32 on themselves, the infant or the changing surface.

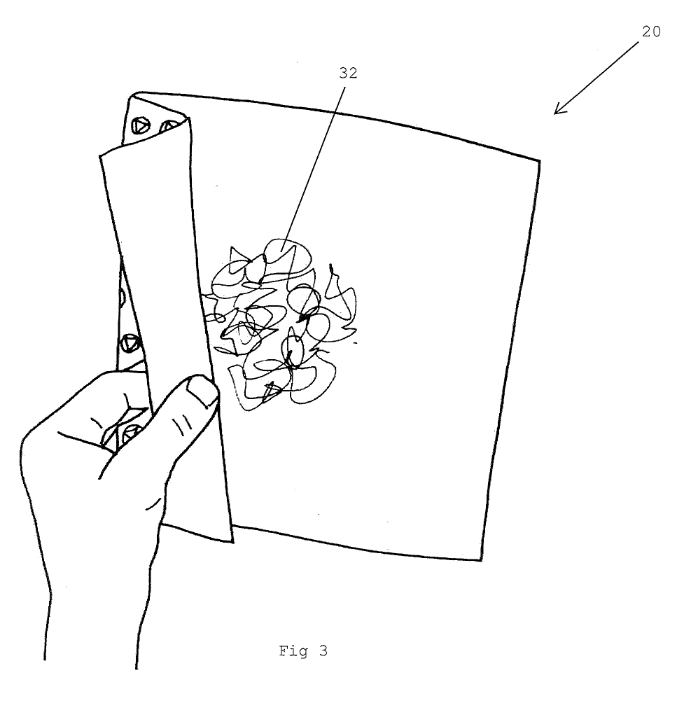

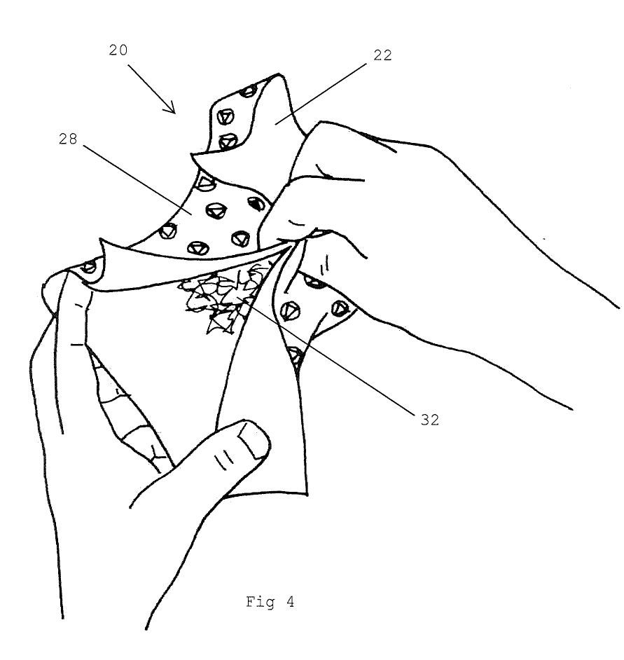

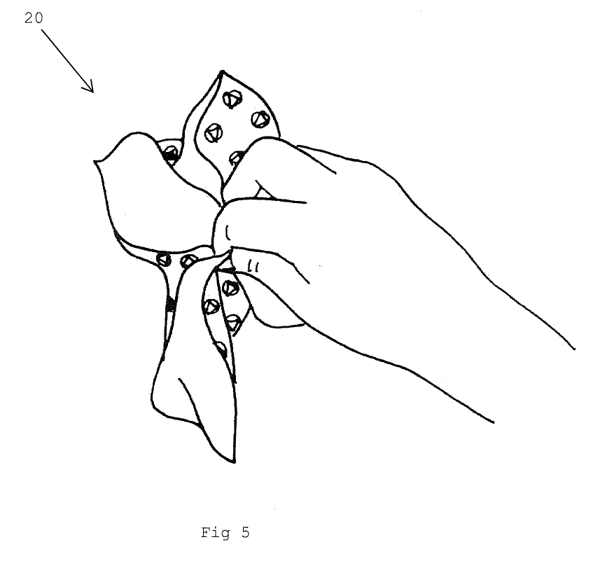

Therefore, the present invention provides a mat in which the soil can be quickly enclosed in the mat and disposed of. Illustrated in FIG. 3 is the mat 20 with soil 32, and wherein the user contains the soil 32 by folding the edges of the mat inwards. As seen in FIG. 4, this encloses the soil 32 and any seeping material is absorbed by the first and second layers 22 and 24, with the third layer 26 preventing any leakage through to the fourth layer 28. FIG. 5 illustrates the soil 32 completely enclosed with the fourth layer 28, now acting as the outer layer protecting the user and the surrounding area from any spillage or leakage of the soil 32.

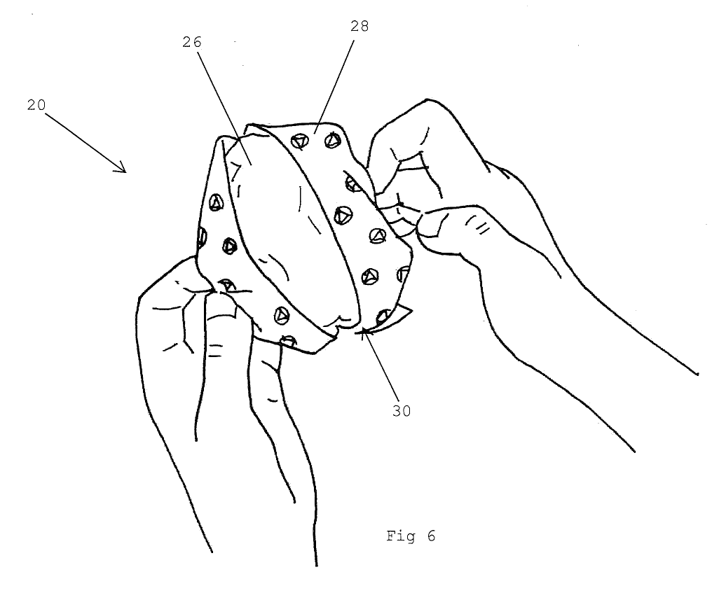

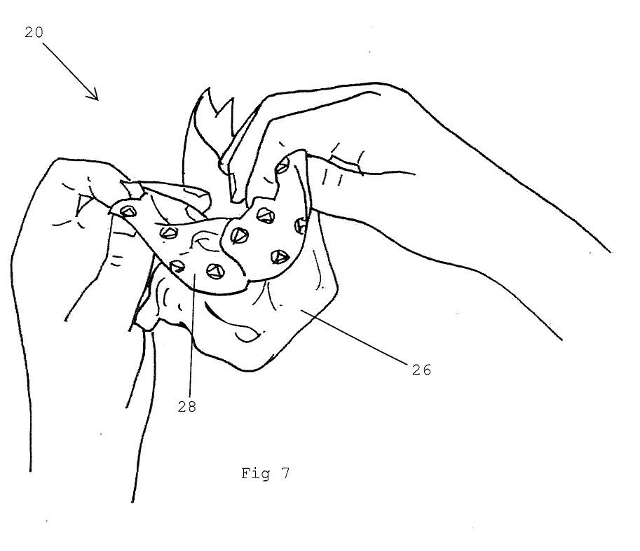

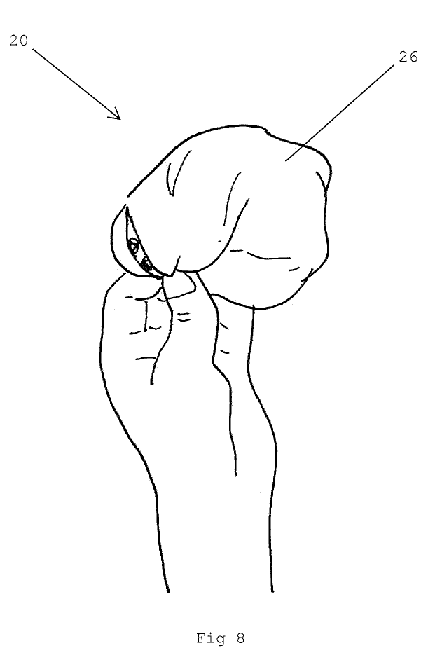

The user then expands the slit 30 to invert the forth layer 28 as illustrated in FIGS. 6 and 7. This is done by the user gently pulling on the open edges of the slit 30 to expose the third layer 26 beneath and completely inverting the fourth layer 28 until the third layer 26 becomes the outer layer as illustrated in FIG. 8. This further insulates the user from the soil 32 and allows the enclosed mat to be easily held and carried to the bin for disposal.

The reader will now appreciate the present invention which is a four layer baby change mat, whereby in the event that the infant soils the mat during changing, it can be easily enclosed within the mat and the outer layer inverted to allow for quick and clean disposal.

In addition the mat may be made of a much bigger size so that even the nappy can be enclosed in the mat when it is inverted.

There may be other uses for the mat and not only for use on an infant. If may be used for example as a mat to be placed under a paint tray so that eventually any paint can be safely disposed of.

The mat may also include images and/or writing that could be educations facts or may contain advertising, health warnings etc.

The mat may also include handles (not shown) so that when it is inverted that may allowed it to be carried before disposal.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A baby change mat comprising:
a base mat comprising a plurality of layers including an outer layer; and
wherein the base mat is foldable inwards and the outer layer of the base mat contains an opening allowing for the outer layer to be inverted in order to enclose base mat for disposal.

2. The baby change mat according to claim 1, wherein the base mat comprises four layers including the outer layer.

3. The baby change mat according to claim 2, wherein the four layers include a first layer, a second layer, a third layer and a fourth layer; and the fourth layer comprises the outer layer; and wherein the first and second layers are absorbent and the third and fourth layers are waterproof.

4. The baby change mat according to claim 1 wherein the outer layer contains a non-slip surface.

5. A method for disposing of a soiled baby change mat as defined in claim 1, said method comprising steps of:
folding edges of the base mat inwards to enclose soil on an upper layer of the base mat;
expanding a slit defined in the outer layer;
inverting the outer layer to enclose the base mat; and
disposing of the base mat.
